(19) United States
(12) Patent Application Publication
(10) Pub. No.: US 2009/0175603 A1
(43) Pub. Date: Jul. 9, 2009

(54) EQUIPMENT GROUP AND PROCEDURE FOR STORAGE OF HEAT ENERGY USING ELECTRIC CURRENT

(76) Inventor: Gabor Gode, Budapest (HU)

Correspondence Address: KATTEN MUCHIN ROSENMAN LLP, 575 MADISON AVENUE, NEW YORK, NY, 10022-2585, US

(21) Appl. No.: 11/817,720

(22) PCT Filed: Mar. 2, 2005
(86) PCT No.: PCT/HU05/00025

§ 371 Date: Sep. 4, 2007

(30) Foreign Application Priority Data
Mar. 3, 2004 (HU) P0400507

(51) Int. Cl. F24H 7/00; F01K 15/00

(52) U.S. Cl. 392/346; 290/2

(57) ABSTRACT

Equipment for storage of heat energy preferably for storage of heat energy by converting electric energy produced by plants utilizing wind energy into heat energy and using the stored heat energy for providing various heat supply services, and, in order to eliminate the disadvantages due to the intermittent operation of plants utilizing wind energy, using the stored heat energy for generating electric energy during windless period; furthermore, storing the energy by means of cheap electric energy produced by the power stations during night and using it during peak load periods.

Energy reserves in the world are limited; their exploitation becomes more and more cost demanding. Especially, the exhaustion of petroleum reserves prognosticated to be crucial by the mid of the century may cause serious problems and shortages in the energy supply; in fact, the replacement of petroleum derivatives burnt up for the most part is not solved at present. At the same time, as a result of burning up fossil fuels, pollutants emitted into the environment cause serious environmental pollution and increase the carbon dioxide content of the atmosphere, thus increasing the “greenhouse” effect with its serious consequences. Sulphur dioxide emitted into the atmosphere leads to acidic rain that damages the biosphere significantly.

For solving these problems that become more and more serious in respect of the present and, to an increased extent, the future of mankind, the increasingly popularized utilization of alternative renewable energy sources—including the wind energy—offer very significant, safe and definite solutions.

The wind power stations, wind engines, wind turbines, wind motors, air wings (hereinafter all together plants utilizing wind energy) come worldwide into use and their share in the electric energy generation shows an increasing trend. Initially, these were used primarily in coastal areas for reason of the favourable possibilities offered by the frequent air currents generated as a result of warming up of the surfaces of land and sea at different times. On the other hand, more and more plants utilizing wind energy are installed in wind-blown mountain areas not contested in respect of environmental protection.

Plants utilizing wind energy that became more reasonable due to the increased state (European Union) support, modernization of equipment and reduced investment cost are installed in an increased number year by year by both contractor groups and individuals.

Plants utilizing wind energy are of intermittent operation—except certain coastal areas—, therefore, it is the intermittent operation that represents the largest disadvantage at present. Due to the intermittent operation, the continuous power supply to certain settlements, groups of settlement, private- and agricultural projects is impossible. A further disadvantage is that there is only a little demand for electricity generated during night hours. Therefore, the continuity of power supply and the storage of electric energy generated during night hours would increase the economic efficiency of plants utilizing wind energy to an enormous extent.

At the same time, the heat storage using electric energy generated during night hours could make it possible to generate excess electric energy during daily peak hours, thus improving the economic efficiency of power stations; in addition, the heat storage could offer a solution for making up the electric energy failed due to the partial breakdown and operational troubles of power stations.

Starting from the above consideration that, in principle, electric energy can be converted into heat energy without losses, this solution includes the objective of invention that the energy storage of plants utilizing wind energy and other power stations can be implemented by means of heat storage with phase conversion using crystalline materials (eutectics) of high heat storage capacity and permanent reversibility that ensure energy storage with high energy density.

The efficient and economic solution of energy storage in the form of heat storage would offer extreme advantages in several respects, especially in the fields of wind energy utilization and heat storage of power stations. It is the alternative renewable energy sources and, in particular, the wind energy that will play the part of energy source that fulfils the increased energy demand of our days to a significant extent even at present and, on the other hand, will offer not only enormous possibilities for the future but take a dominant share in the in the energy utilization in this century; in fact, the propagation of plants of this kind in a wider circle enables the petroleum derivatives to be replaced. The importance of this lies in the time scale of cost free energy source that can be measured in billions of year, the advantages of operating the heat storage in high temperature ranges and, consequently, their more versatile utilization as well as the possibility of their use in an environmentally friend way.

In the energy utilization, the heat supply services provided in various temperature ranges occupy a very significant place. The efficient and economic heat storage can offer enormous possibilities unused so far to replace traditional energy carriers in several fields, i.e. the heating and warm water supply for homes, communal establishments, office buildings, industrial processing plants, livestock farms, foil stalls, greenhouses etc., heat supply to the industrial procedures that require heat energy, drying procedures in the agriculture and food industry, heat treatment procedures of food industry and other processing activities that require heat energy. The utilization of all these possibilities can open up a new prospect for the propagation of wind energy utilization in a wide circle and for the improved efficiency of power stations.

The mobile version of heat storage equipment enables the problem of continuous heat supply to industrial-, processing- and communal projects requiring high heat capacity to be solved in a way that a mobile, transportable or self-propelled heat storage tank vehicle of high heat storage capacity is connected to the electric connection point or other heat transfer connection point of equipment utilizing wind energy or power station and, after a quick recharging, the vehicle delivers the stored heat energy directly to the user equipment or an installed heat storage equipment by means of quick discharge. These mobile heat storage units connected to the conventional heating systems and heat suppliers can also be efficiently used for transporting heat energy in order to bridge the distance between the heat producing plants and the users.

At present, different forms of heat storage procedures are known. As for the types of storage system, there are equipment for the storage of sensible heat and latent heat. For the storage of sensible heat, solid materials are the most suitable. Solid materials heated and cooled store the heat without phase change. It is the sensible entalpy that determines the storage capacity. In this heat storage method, two various procedures can be distinguished: in one of them, it is the solid material itself that transports the heat from the heat storage tank e.g. in case of gravel-bed systems; while in the other procedure, the solid material remains in the heat storage tank and the heat is transported by some liquid or gaseous medium.

If the storage medium is a solid body and a proper design is used, the “thermoclin” effect can quite easily be implemented: in a thin cylinder, the heat transporting medium flows axially and this is characterized by short heat transport distances, large heat transfer surfaces but axially a low thermal conductivity. Along the height of the heat storage vessel, the heat distribution during the recharge and discharge is developed in three different ways: in the first case, the heat transfer surface and heat transfer coefficient is low compared to the flow—e.g. cowper system; in the second case the relationship is inverse—e.g. in case of gravel bed. In both cases, axial heat transfer takes place which makes the temperature diagram more flat. In the third case, a temporary temperature range is developed that wanders up and down during the recharging and discharging similar to the blending range in a displacement type clean liquid container. Its advantage is that the outlet temperature is virtually constant nearly up to the end of discharge. Its disadvantage, however, is that the heat transfer liquid must flow through all the system with pressure drop along its way, while heat transfer occurs only in a relatively narrow temporary zone.

As a general rule, solid storage media have high volumetric specific heat storage capacity and a wide range of temperature change; in most cases, however, this is not utilized to the full. Among the metals, it is the cast iron that is of the highest heat storage capacity, with the disadvantage of its significant mass per volume. In respect of heat storage capacity, alumina (Al₂O₃) and magnesia (MgO) have high heat storage capacity, however, they are expensive heat storage materials.

The heat storage through latent heat is related to the phase change of the storage medium at a constant temperature rather than to temperature change. The highest latent heat is connected to the transition from liquid phase to gaseous phase. Its disadvantage is, however, that the volumetric heat storage capacity of vapour phase is rather low; therefore, heat storage of this kind using latent heat is not used. In most cases, storage of latent heat means the storage of melting heat which involves only small volumetric change. The advantage of heat storage based on phase change is that, in addition to the latent heat, the sensible heat of both the liquid- and solid phases can also be used. The latent heat storage device (container) consist in a system of constant mass at a constant temperature. Its important feature is that the storage capacity increases with the temperature. Using a mixture of two components, especially eutectic or more components the melting point can be reduced without decreasing the entalpy of phase transition significantly.

In respect of storage medium, pure materials, component and three-component systems are distinguished.

From the pure materials, lithium fluoride (LiF) has the highest melting heat while the lithium hydroxide (LiOH) is nearly the same, with very favourable melting point in respect of a number of processes. The only disadvantage of these materials is that they are cost demanding when used in their pure form; therefore, these disadvantages can be mitigated by mixing with other materials of good heat storage capacity to form eutectics.

The use of two-component systems is made very favourable by the fact that their melting point lies in a more favourable low temperature range, they enable high energy density to be obtained even in case of low melting point and, in addition, expensive materials of high heat storage capacity can be mixed with less expensive ones so as to preserve nearly the same heat storage capacity. Within this two-component system eutectic and distectic mixtures can be distinguished. Due to their advantageous properties, the eutectic mixtures are the most convenient.

The thermal characteristics of three-component systems is similar to those of two-component systems; however, their melting point and price is lower; therefore, they are very favourable for economic heat storage of high efficiency.

The gas storage under pressure and other heat storage systems e.g. sorption heat storage and thermo-chemical heat storage shall also be mentioned.

Gas storage under pressure includes the pressurized air underground systems exceeding as much as 100 000 m³ used to operate gas turbine peak load power stations. In the pressurized storage systems, the isothermic discharge can be approximately implemented if the discharge is low and heat exchange with the environment takes place or a separate latent heat storage system is used. The heat storage can be improved if further heat storage capacity e.g. latent heat storage is available. In this case, the temperature decrease during the discharge is reduced and no unnecessary heat stresses are induced. The energy density increases with the storage pressure to an extent larger than linear; therefore, high pressure (above 50 bar) is recommended to be used for storage under pressurized air. All these circumstances hinder the significant propagation of this system.

There are four basic solutions for the sorption storage. In the first one, heat is added to the sorbent agent, and the desorbed one is led to a gas reservoir that operates at either constant or floating pressure. The storage capacity increases with cooling down the gas. The disadvantage of system lies in its low energy density. In the other solution, if the gas is condensed at the ambient temperature or its vicinity, it requires less volume The condensation heat is released into the atmosphere. During the discharge, the environmental heat re-evaporates the liquid, thus the energy is lost in full. In the third solution, the liquid storage is replaced by sorption storage which operates with further absorber agent which is capable of absorbing and desorbing at ambient temperature. In the fourth solution, the combination of sorption storage and heat engine is implemented. If the discharge valve is opened, the steam flows from the boiler through the steam engine into the storage tank, heat energy is released which is led to the boiler, thus preserving the steam generation. Its disadvantage is that, although the sorption heat is of favourable value, the energy density is low due to the low mass density of the absorbing salt.

The essence of thermo-chemical storage is that the heat energy is stored in the form of bonding energy of reversible chemical reactions. The reaction can take place either with or without catalyzers present. With the reaction completed, the participating materials shall be separated and stored separately. In this procedure, heat of evaporization is released during condensation (charging) that remains unused which impairs the efficiency of storage. Another disadvantage is that, in respect of the service life of catalyzers and structural materials, difficulties arise.

The latent heat storage allows higher energy density compared to the sensible heat storage to be obtained. Pressurized systems with saturation pressure exceeding the atmospheric pressure require pressurized vessels to be used; therefore, these systems are uneconomical due to the high pressure. The sorption heat storage requires at least one pressurized vessel, while the thermo-chemical heat storage requires several ones of various pressure provided that the materials participating in the reaction are stored in their liquid phase; these and the lower energy densities represent the disadvantage of these systems.

The latent heat storage systems are more favourable than those listed above; in fact, the constant discharge temperature ensures higher efficiency as compared to that of sensible heat storage systems with decreasing temperature. In respect of heat energy utilization, their further advantage is that the sensible heat of the solid phase, the latent heat of the phase conversion and the sensible heat of the liquid phase can be utilized.

In the procedure according to the invention, the starting point was the recognition that, among the heat storage systems known and used at present, it is the solid storage media with phase conversion using non-metallic carrier of the highest energy density and constant discharge temperature that are the most favourable. These heat storage media, however, fail to meet the requirements in respect of cost effectiveness, reversibility, the favourable melting point and corrosive properties against structural materials in each case. Starting from this recognition, the procedure according to the invention solves the problem of using eutectics that, according to the experiments performed, show constant reversibility, their melting point is favourable in respect of the use, have high heat storage capacity and cause no corrosion to the structural materials.

The U.S. Pat. No. 4,244,350 describes a solution different from the above, that relates to a solar energy operated heat storage tank in which a heat transfer procedure is implemented. In the procedure, overheated steam is generated by means of steam heated in a superheater pipe system. The efficiency of the equipment, however, is low and is unable to be used for long term heat storage.

The U.S. Pat. No. 4,391,267 describes a heat storage material the essence of which is that, by means of a phase transition, a liquid crystalline melt is converted—at a specific temperature—either spontaneously or artificially via coring into crystallized form. During coring, an additive is added to the melt, which is dissolved and a mixture is formed. The additive may contain disodium hydrogen phospate, dipotassium hydrogen phosphate or their ammonium or sodium equivalent. In the solidifying material, the additive promotes the regulation of size and growth of crystals and prevents the melt from being crystallized in the undesirable hydrate form.

The essence of the solution is that, during heating, the material that stores the heat necessary for the phase transition is melt and, thus, heat is released during the re-crystallization. The description, however, presents only a process that promotes the crystallization and fails to deal with the continuous re-utilization of the crystallized material. Another disadvantage is that the problem of heating up the crystallized material is not solved and, thus, its re-utilization is not made possible.

The U.S. Pat. No. 4,355,627 presents a heat storage system operating with solar collector or heat pump. Its essence is that individual heat tanks of regular geometry form a pile in a larger collector container. The shell of heat tanks contains heat conducting material e.g. glass, metal parts that also includes the heat storage material itself.

The deficiency of this version is that a melt produced from non-crystalline material by heating, i.e. heat other than that released from phase conversion is utilized for heat storage, therefore, it is unable to obtain high heat storage capacity and long term heat storage.

According to the objectives set, the invention relates to an equipment group or procedure for storage of heat energy, preferably for storage of heat energy produced by electric energy generated by plants utilizing wind energy or by thermal power stations. In said equipment group and procedure, the heat energy transported from the heat generating plant by means of a heat carrying medium is stored by using a phase conversion method in a manner that the crystalline material of favourable heat storage capacity, preferably some crystallized eutectic contained in the heat storage tank of the heat storage equipment is heated by means of the hot heat carrying medium arriving from the heat source until the crystalline material while melting is filled with and stores the heat during its phase conversion and, then, in the discharge mode, by circulating the heat carrier medium from heat exchanger or heat utilizing equipment, the melt is cooled down up to the completion of the phase conversion i.e. the re-crystallization and/or its optimum cooling down, thus, the stored heat energy is recovered; in said process, crystalline materials and/or eutectics are used during the procedure that preserve their reversibility during repeated phase conversion processes unchanged, enter into reaction with the used structural materials only to a small extent or not at all, have insignificant corrosive properties and their thermal parameters make a high level of phase conversion heat storage possible.

An advantageous property of the heat storage equipment group is that, using a heat generating equipment heated by means of electric energy produced by plants utilizing wind energy or power stations, the electric energy can be converted into heat energy with low losses; being said heat energy transported by means of the heated up heat carrier medium to the heat storage tank and, by melting the crystalline heat storage material (eutectic) in the heat tank, a phase conversion heat storage of high energy density is implemented.

A further criterion of the heat storage equipment group according to the invention may be that the heating/cooling pipelines of the heat storage tank and, in case of stationary equipment, the heating pipelines of heat exchanger are of ribbed surface in order to improve the heat transfer.

The advantageous properties of the heat storage equipment group according to the invention is improved by that the temperature monitoring, status detection and actuating devices are connected through the control unit to an electronic data processing device e.g. a computer.

In a preferred embodiment of the mobile and transportable heat storage equipment according to the invention, the inlet- and outlet stubs of heating/cooling pipelines to and from the heat storage tank are provided with connecting devices that, for the purpose of filling the mobile heat storage equipment with heat energy, are suitable to be connected to its heat generating equipment heated by means of electric energy produced by plants utilizing wind energy or power stations or other heat transfer points.

The purpose of heat storage equipment group and procedure according to the invention is to eliminate the disadvantages arising from the unsolved problems of energy storage and, by implementing a heat storage equipment group using the most effective heat storage method i.e. the phase conversion with good efficiency and reasonably and by minimizing the convection losses, thereby making the long term storage and versatile utilization of the heat energy possible.

Another objective of the invention is that, by implementing heat storage equipment of mobile and transportable design, in order to forward the received and stored heat energy directly to the consumers without building pipeline systems used for district heating, thus obtaining further advantages by utilizing the free energy source, on the one hand, and by using the most economic way of heat transport, on the other hand.

A further objective of the invention is that the heat storage procedure proved to be the most favourable according to both the professional literature and the practice from among the heat storage methods—although implying a number of technical problems at present—, i.e. the heat storage procedure utilizing the phase conversion heat of crystalline materials is used in a manner that a heat storage procedure of stable operation, high efficiency and economic operation is implemented, using mixtures and/or eutectics from among heat storage crystalline materials that show constant reversibility proven by experiments, have favourable melting point in respect of the utilization, high melting heat and high heat storage capacity as well as cause no corrosion to the structural materials to be used in the implementation.

According to the objectives set, the group of equipment according to the invention for storage of heat energy—preferably for storage of heat energy produced by electric energy generated by plants utilizing wind energy or by power stations—that has a primary pipeline serving for transporting the hot heat carrier medium and a secondary pipeline serving for transporting the cooled down heat carrier medium connecting one or more of its heat generating subassemblies to the heat storage tank, being said primary and/or secondary pipeline transporting the heat carrier medium is provided with one or more associated units circulating the heat carrier medium, e.g. circulating pumps, and the heat storage equipment has a heat storage tank filled with a crystalline material to implement the heat storage by phase conversion, being said heat storage tank provided with heating/cooling pipelines embedded into the crystalline material and/or its melt to transport the heat carrier medium for the purpose of filling it with the heat transported from the heat generator and extracting the stored heat for utilization, being the outlet section or sections of said pipelines connected with the insertion of valves and circulating pump to the primary pipelines arriving from the heat generating subassembly and serving for transporting the heat carrier medium and the secondary pipelines led to the heat generating subassembly; with the interconnection of said valves, circulating pump and connecting pipelines to one or more heat exchangers and/or without heat exchanger to one or more heat utilizing equipment and said heat storage tank and heat generator as well as the heat exchanger, furthermore, the primary and secondary pipelines transporting the heat carrier medium and their connecting pipelines are provided with heat insulating cover; the heat storage tank and the heat generator as well as the heat storage medium, the pipelines transporting the heat carrier medium, the heat carrier medium, and the heat exchanger are provided with temperature monitoring subassemblies suitable to measure and signalling the temperature of said media, state detecting devices serving for indicating the parameters of media as well as actuating devices suitable to alter certain parameters; the heat storage tank of the heat storage equipment as well as the primary pipeline of the pipeline system transporting the heat carrier medium is connected with the insertion of a connecting pipeline to an expansion tank filled with some inert gas preferably nitrogen; and basic units consisting of the heat storage tank and the associated subassemblies as well as the heat generator are established that can be interconnected according to the needs for heat storage and heat utilization.

The invention relates to an equipment group for storage of heat energy in which the heat storage equipment as a basic unit is designed in the form of a transportable mobile system as e.g. one or more heat storage tanks arranged in a container transported by vehicles, being said heat storage tank filled with crystalline heat storage material, provided with heating and cooling pipelines, outlet connecting stubs, heat generating equipment heated with electric current and heat insulating cover, temperature monitoring-, state detecting and actuating devices; furthermore, a self propelled heat storage tank car and railway wagon implemented with the same devices.

Another advantage of the heat storage equipment group according to the invention that a warm water production unit, preferably a warm water storage boiler can be connected via heat exchanger to the heat storage equipment.

Further advantages in the fields of utilization of the heat storage equipment group according to the invention are that the heat utilizing equipment connected to the heat storage equipment can serve for fulfilling any demand for heat energy e.g. heating through heat transfer or heat transmission units, cooling/heating when connected to air conditioning equipment, cooling when connected to absorption cooling equipment, heat supply to drying equipment and, in addition, any industrial processing activity requiring heat energy, fulfilling the head demand of thermal energy providers and customers.

Based on the drawing presenting the exemplary embodiments, the invention is described below.

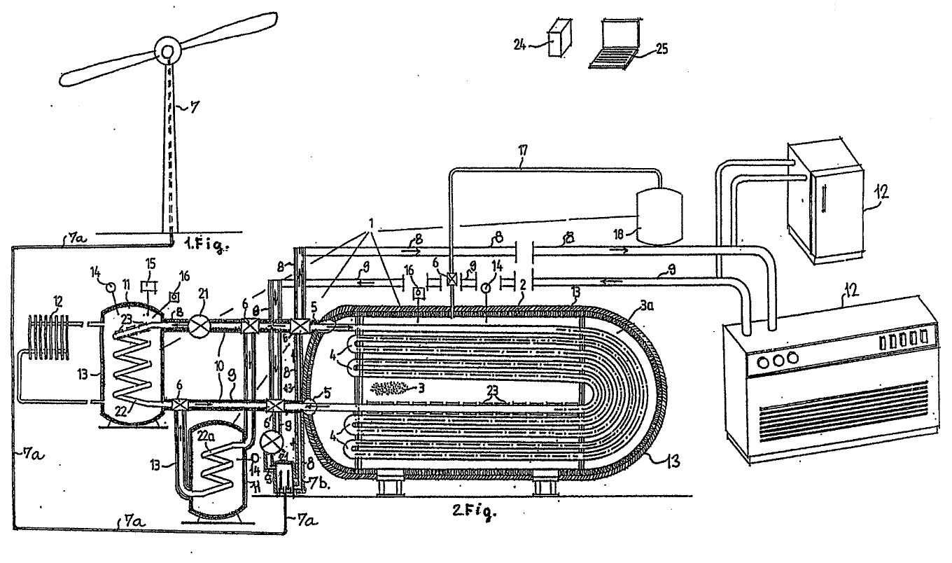

FIG. 1 shows that the electric current from the 7 subassembly generating the electric current is led through the 7a electric cable to the 7b heat generator from where the 8 primary pipeline transporting the heated up heat carrier medium with the insertion of 21 circulating pump and 6 valve through the 5 inlet stub connects to the 4 heating-cooling pipeline of 2 heat storage tank and, from the 5 outlet stub at the end of 4 heating-cooling pipeline through the 6 valve and the 9 secondary pipeline, returns to the 7a heat generator subassembly, thus closing the circle serving for heating the 2 heat storage tank, i.e. its filling with heat energy.

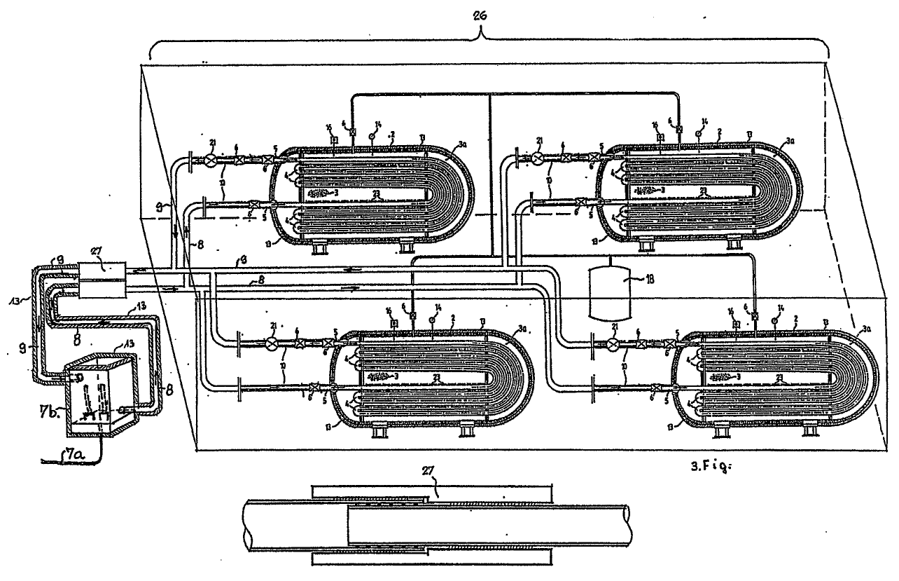

FIG. 2 shows the 2 heat storage tank of the 1 heat storage equipment forming the basic unit, the 11 heat exchanger connected to the 2 heat storage tank, the 11a boiler to produce warm water and the 18 expansion tank filled with inert gas.

The 2 heat storage tank of 1 heat storage equipment is shown in FIG. 2, being said 2 heat storage tank filled with 3 crystalline heat storage material and 4 heating-cooling pipelines transporting the 20 heat carrier medium are embedded in the said 3 crystalline material and in its 3a melt, respectively.

FIG. 2 also shows that the 11 heat exchanger is connected through 6 valves and 10 connecting pipelines to the 2 heat storage tank, being said 11 heat exchanger connected through pipelines with the 12 heat utilizing equipment.

Through this flow of the 20 heat carrying medium from the 2 heat storage tank through the 6 valve and 10 connecting pipeline to the 11 heat exchanger and, then, returning from the 11 heat exchanger through the 10 connecting pipe and 9 secondary pipe and 6 valve to the 2 heat storage tank the cooling-discharging circuit is closed.

From FIG. 2, in can be shown that the 2 heat storage tank and the 11 and 11a heat exchangers and, in addition, the 8 primary and 9 secondary pipelines are provided with 13 heat insulating cover; furthermore, the 2 heat storage tank, the 7b heat generating equipment, the 3 heat storage charge, the 8 primary and 9 secondary pipelines, the 11 and 11a heat exchangers are provided with 14 temperature monitoring subassembly suitable to measure and indicate the temperature of 20 heat carrying medium, 15 state detecting devices serving for indicating the parameters of media as well as 16 actuators serving for altering the individual parameters.

In addition, FIG. 2 also shows that the 2 heat storage tank, and the 8 primary pipeline transporting the 20 heat carrying medium is connected through the 17 connecting pipe with the 18 expansion tank filled with inert gas.

FIG. 2 shows a preferred exemplary embodiment in which the 4 heating-cooling pipelines of the 2 heat storage tank as well as the 22 heating pipelines of the 11 and 11a heat exchangers are of ribbed surfaces in order to improve the heat transfer.

FIG. 2 also shows that the 14 temperature monitoring devices, the 15 state detecting devices and the 16 actuating devices all these associated with the 1 heat storage equipment group are connected through the 24 control unit with an electronic data processing device e.g. computer.

Another preferred exemplary embodiment is shown in FIG. 2 in which the 11a warm water producing and storage boiler is connected to the 1 heat storage equipment.

FIG. 3 shows a 26 mobile and transportable design of the 1 heat storage equipment, with the 4 heating-cooling pipelines running in the 2 heat storage tanks filled with 3 crystalline material, provided with 6 valves, 21 circulating pumps, 5 outlet connecting stubs, 19 switching devices, 13 heat insulating cover, 14 temperature monitoring-, 15 state detecting and 16 actuating devices.

FIG. 3 shows another exemplary embodiment of the 26 mobile and transportable heat storage equipment where the 4 heating-cooling pipelines of the 2 heat storage tank are provided with 23 ribbed surface in order to improve the heat transfer in both direction.

FIG. 3 also shows that the 14 temperature monitor, the 15 state detecting- and the 16 actuating devices are connected through a 24 control unit to a 25 electronic data processing device, e.g. computer.

FIG. 3 also shows that the 5 stubs on the inlet- and outlet sections of the 4 heating-cooling pipelines of the 2 heat storage tank in the 26 mobile and transportable heat storage equipment are provided through the insertion of 6 valve with disconnectable 27 connecting devices that are connected with 7b heat generating equipment heated by electric current generated by 7 plants utilizing wind energy or power stations and led through 7a electric lines in order to fill the 26 mobile heat storage equipment with heat energy. At the place of receiving the heat supplied, flexible pipelines provided with rigid connecting extensions adapted to the 27 connecting devices that serve for connecting with the 27 connecting devices are arranged, that connect the 2 heat storage tank of the 26 mobile and transportable heat storage equipment in a disconnectable manner with the 12 heat utilizing equipment.

When operating the equipment group according to the invention, the 20 heat carrying medium circulated in the 7b heat generating equipment heated by electric current produced by 7 plants utilizing wind energy or power stations, preferably thermo oil, is heated up to appropriate temperature and, this hot 20 heat carrying medium is led by means of the 21 circulating pump through the 8 primary pipeline, 6 valve and the 5 inlet stub into and circulated through the 4 heating-cooling pipeline system of the 2 heat storage tank arranged in an appropriate closed room, during which the hot 20 heat carrying medium warms up and melts the 3 crystalline material filled in the 2 heat storage tank continuously and, the 20 heat carrying medium cooled down returns through the 5 outlet stub and the 6 valve and 9 secondary pipeline to the 7b heat generating equipment, thus, the filling up cycle is closed.

In discharge mode, the operation of equipment is as follows: the 25 computer compares the data received from the temperature monitoring or temperature control devices mounted in the rooms to be heated and on the heat utilizing equipment (e.g. drying equipment), respectively, with the preset (programmed) data and, based on the result obtained, starts the heating-discharging process in which the 20 heat carrying medium is circulated by the 21 circulating pump through the 10 connecting pipeline starting from the 22 heating pipeline of 11 heat exchanger and, at the same time, the 6 valves mounted both in the 8 inlet stub of the 8 primary pipeline and in the 5 outlet stub of the 9 secondary pipeline are opened. Thus, the flow of 20 heat carrying medium from the 11 heat exchanger through the 4 heating-cooling pipelines of 2 heat storage tank is started, during which the 20 heat carrying medium while flowing through the 4 heating-cooling pipelines of the 2 heat storage tank, takes up the phase conversion heat and, then, the sensible heat of 3a melt produced by melting the 3 crystalline material using electric energy, is heated up and, returning into the 11 heat exchanger and flowing through the 22 heating pipeline of 11 heat exchanger, warms the water contained in the 11 heat exchanger. The water warmed up in the 11 heat exchanger is forwarded by the 21a circulating pump through the connected 8a primary pipeline to the 12 heat utilizing equipment where the warm water transfers its heat energy and returns through the 9a secondary pipeline to the 11 heat exchanger, thus closing the heating circuit.

During the operation, the storage type 11a warm water producing boiler of flow through system connected to the 2 heat storage tank of the 1 heat storage equipment opens the built-in thermostat and the 6 valves, based on the pulse received from the 14 temperature monitoring device; the 21 circulating pump drives the hot 20 heat carrying medium through the 8 pipeline and the 22a heating pipeline of the 11a warm water producing boiler, thus warming up the water stored in the storage type 11a warm water producing boiler; then, the warm water is released by opening the water cocks mounted in the home. At the same time, the 20 heat carrying medium thus cooled down returns from the 22a heating pipeline of the 11a warm water producing boiler through the 9 secondary pipeline to its starting point.

The 1 heat storage equipment is provided with 14 temperature monitoring device suitable to measure and indicate the temperature of 7b heat generating equipment, the heat carrying medium and the 3 heat storage material, with 15 sate sensing devices serving for indicating the parameters of media; with 16 actuators serving for altering the individual parameters, that are connected through the 24 central control unit to the 25 computer and continuously supply data into the memory of the 25 computer during operation.

The computer compares the data received with the pre-programmed data and, according to the result obtained, controls the flow of the heat carrying unit by the appropriate operation of the 21 circulating pumps, the 6 valves and other control elements, on the one hand, and the necessary heat supply to the 11 heat exchanger and/or the warm water producing boiler by opening the 6 valves in part or in full, on the other hand.

All the above are required in order to prevent the 20 heat carrying medium from being overheated by controlling its flow, on the one hand, and to ensure the heating and warm water supply according to the needs by means of controlled operation of 6 valves and 21 circulating pumps, on the other hand.

An advantageous feature of the invention is that, by using crystalline materials of high melting point in the 2 heat storage tank, the stored heat energy can be used to produce electric energy.

It is an advantage of the heat storage equipment according to the invention that, using the steam generated in the power stations—irrespective of its temperature and pressure—, the heat energy of flue gases as well as the waste heat of condensation and by means of a crystalline or eutectic of melting point selected appropriately according to the given temperature ranges, the filling of heat storage equipment with heat energy can be performed. The heat energy thus stored can be used for production of electric energy or for various heat supply services.

The operation of the 26 mobile and transportable design of the 1 heat storage equipment is essentially the same as that of the stationary 1 heat storage equipment described above. The difference lies in that in this type of equipment, the 11 heat exchanger can be omitted, and the 5 inlet- and outlet stubs on the 4 heating-cooling pipelines of the 2 heat storage tank are provided with 27 connecting devices connected to 6 valves that enable the 26 mobile heat storage equipment to be filled with heat energy by connecting it to 7b heat generating equipment heated with electric energy produced by 7 plants utilizing wind energy or power stations.

During operation, the 26 mobile heat storage equipment is connected by means of the 27 connecting devices to the 7b heat generating equipment and, by operating the 6 valves and the 21 circulating pumps the 2 heat storage tank of the 26 mobile heat storage equipment is filled with heat energy through the circulation of 20 heat carrying medium.

When discharging, the 27 connecting devices provided with the 6 valve connected to the 5 outlet stub on the 8 primary pipelines of the 2 heat storage tanks used individually or connected together that are transported to the site of heat supply and arranged in a container or moved as a self-propelled tank vehicle are connected through a flexible pipeline provided with a rigid connecting extension adapted to the 27 connecting devices directly to the 12 heat utilizing equipment or a stationary 2 heat storage tank, the 6 valve is opened and, while circulating the 20 heat carrying medium by means of the 21 circulating pump, the stored heat is transferred to the 12 heat utilizing equipment or the stationary 2 heat storage tank.

At the same time, the 20 heat carrying medium cooled down is returned from the heating pipeline system of the 12 heat utilizing equipment or the stationary 2 heat storage tank through the flexible pipe connected to the 27 connecting devices by means of a rigid extension and the 9 secondary pipeline to the 2 heat storage tank of the 26 mobile heat storage equipment.

The procedure according to the invention is implemented by the operation in which the 3 crystalline material of favourable heat storage capacity, preferably 3 eutectic contained in the 2 heat storage tank of the 1 heat storage equipment is heated by means of the 20 hot heat carrying medium arriving from the 7b heat source as long as the 3 crystalline material when melting is filled with heat energy during the phase conversion and the heat is stored and, then, in the discharge mode, by circulating the heat carrying medium from the 11 heat exchanger or in case of 26 mobile heat storage equipment, from the 12 heat utilizing equipment, the 3a melt is cooled down until the completion of phase conversion or re-crystallization and/or until it is cooled down to the desired extent, thus, the stored heat energy is extracted and/or transferred.

During the procedure, crystalline materials and eutectics are used that preserve their reversibility during repeated phase conversions unchanged, enter into reaction with the structural materials only to a significant extent or not at all, are non-corrosive or only to a small extent, and their parameters make the storage of phase conversion heat possible to a large extent.

A further advantage of the procedure according to the invention is that it offers the possibility of utilizing not only the storage of latent heat during phase conversion but also the sensible heat of both the crystallized and liquid phases.

1. Equipment for storage of heat energy preferably for storage of heat energy by converting electric energy produced by plants utilizing wind energy into heat energy and using the stored heat energy for providing various heat supply services, and, in order to eliminate the disadvantages due to the intermittent operation of plants utilizing wind energy, using the stored heat energy for generating electric energy during windless period; furthermore, storing the energy by means of cheap electric energy produced by the power stations during night and using it during peak load periods characterized by that the heat storage equipment (1) has a heat storage tank (2) filled with a crystalline material (3) implementing the phase conversion heat storage, being said heat storage tank (2) connected with one or more heat generating equipment (7b) where in the heat generating equipment (7) heated by means of electric current arriving through electric line (7a) from an electric energy generating plant, preferably a plant utilizing wind energy (7b) the cooled down heat carrying medium that arrives from the secondary pipeline (9) with the interconnection of valve (6) and (pump) is heated up and is fed through the primary pipeline (8) to the pipeline transporting the heat carrying medium (4) of the heat storage tank (2) for the purpose of storing the heat energy and recover the stored heat energy during discharge; heating (4)-cooling (4) pipelines embedded into the crystalline material (3) and/or its melt (3a) in the heat storage tank (2) to transport the heat carrier medium (20), being the outlet section or sections (5) of said pipelines with the insertion of valves (6) and circulating pump (21), the primary pipelines (8) of the hot heat carrying material (20) from the heat storage tank (2) connected to one or more heat exchangers (11) and/or to a heat utilizing equipment (12) with or without heat exchanger and, in the heat utilizing equipment (12), the secondary pipeline (9) containing the heat carrying medium cooled down (20) is connected to the heat generating equipment (7b) and/or to the pipeline (4) of the heat storage tank (2); the said heat generating equipment (7b) and heat storage tank (2) and the heat exchanger (11) and as the primary and secondary pipelines (8), (9) transporting the heat carrier medium as well as the connecting pipelines (10) are provided with heat insulating cover (13); the heat generating equipment (7b) and the heat storage tank (2), the pipelines transporting the heat carrier medium (8) and the heat exchanger (11) are mounted with temperature monitoring subassembly (14) suitable to measure and indicate the temperature of the heat storage medium and heat carrying medium and the said media, respectively, state detecting devices (15) serving for indicating the parameters of media, as well as actuating devices (16) serving for altering the individual parameters; the heat storage tank (2) of the heat storage equipment (1) and the primary pipeline (8) of the pipeline system transporting the heat carrying medium is connected with the interconnection or a connecting pipe (17) to an expansion tank (18) filled with inert gas; and basic units consisting of the heat storage tank (2) and the associated subassemblies are established that can be interconnected according to the needs for heat storage and heat utilization.

2. Equipment group for energy storage, characterized by that a heat generating equipment (7b) heated by means of electric energy produced preferably by a plant utilizing wind energy (7) serves for melting the crystalline heat storage material (3) and for the heat storage implemented with it, performing said heat generating equipment (7b) the warming up of the cooled down heat carrier medium that arrives from the secondary pipelines (9) of the heat utilizing equipment (12) or the heat storage tank (2) through valve (6) and circulating pump (21) and the heat generating equipment (7b) is connected through the primary pipeline (8) to the pipeline (4) of the heat storage tank (2) transporting the heat carrier medium.

3. Equipment group for energy storage, characterized by that the heat storage equipment (1) as a basic unit is designed in the form of a transportable mobile system as e.g. one or more heat storage tanks (2) arranged in a container transported by vehicles, being said heat storage tank (2) filled with crystalline heat storage material (3), provided with heating and cooling pipelines (4), heat generating equipment (7b) operated with electric current, outlet connecting stubs (5), connecting devices (19), heat insulating cover (13), temperature monitoring (14)-, state detecting (15) and actuating devices (16); furthermore, a self propelled heat storage tank car and railway wagon implemented with the same devices.

4. Procedure for storage of heat energy preferably for storage of heat energy arising from conversion of electric energy produced by plants utilizing wind energy or by thermal power stations, characterized by that the heat energy transported from the heat source by means of a heat carrier medium (20) is stored by using a phase conversion method in a manner that the crystalline material of favourable heat storage capacity (3), preferably some crystallized eutectic (3) contained in the heat storage tank (2) of the heat storage equipment (1) is heated by means of the hot heat carrying medium arriving from the heat source (7a) until the crystalline material (3) while melting is filled with and stores the heat during its phase conversion and, then, in the discharge mode, by circulating the heat carrying medium (20) from heat exchanger (11) or heat utilizing equipment, the melt (3a) is cooled down up to the completion of phase conversion i.e. re-crystallization and/or its optimum cooling down, thus, the stored heat energy is recovered; in said process, crystalline materials and/or eutectics are used during the procedure that preserve their reversibility during repeated phase conversion processes unchanged, enter into reaction with the used structural materials only to a small extent or not at all, have insignificant corrosive properties and their thermal parameters make a high level of phase conversion heat storage possible.

5. Heat storage equipment as in claim 1, characterized by that the heating-cooling pipelines (4) of the heat storage tank (2) as well as the heating pipelines (22) of the heat exchanger (11) are of ribbed surfaces (23) in order to improve the heat transfer.

6. Heat storage equipment as in claim 4, characterized by that the heating-cooling pipelines (4) of the heat storage tank (2) as well as the heating pipelines (22) of the heat exchanger (11) are of ribbed surfaces (23) in order to improve the heat transfer.

7. Equipment group as in claim 1, characterized by that the temperature monitor (14), the state detecting devices (15) and the actuating devices (16) are connected through a control unit (24) to an electronic data processing device (25) e.g. computer.

8. Equipment group as in claim 4, characterized by that the temperature monitor (14), the state detecting devices (15) and the actuating devices (16) are connected through a control unit (24) to an electronic data processing device (25) e.g. computer.

9. Mobile and transportable heat storage equipment as in claim 3, characterized by that the outlet- and inlet stubs (5) on the heating-cooling pipelines (4) of the heat storage tank (1) are provided with connecting devices (27) by means of which the filling of the mobile heat storage equipment (26) with heat energy can be performed using electric energy produced preferably by plants utilizing wind energy or power stations.

10. Equipment group as in claim 1, characterized by that a warm water production equipment, preferably a warm water production and storage boiler can be connected to the heat storage equipment (1).

11. Equipment group as in claim 1, characterized by that a warm water production equipment, preferably a warm water production and storage boiler can be connected to the heat storage equipment (1).

12. Equipment group as in claim 1, characterized by that the heat utilizing equipment to be connected to the heat storage equipment (1) can serve for fulfilling any heat demand, e.g. heating through heat transfer or heat transmission units, heating-cooling when connected to air conditioning systems of absorption system, cooling when connected to absorption cooling equipment, heat supply to drying equipment and, in addition, any industrial processing activity requiring heat energy, fulfilling the head demand of thermal energy providers and customers.

13. Equipment group as in claim 1, characterized by that the heat utilizing equipment to be connected to the heat storage equipment (1) can serve for fulfilling any heat demand, e.g. heating through heat transfer or heat transmission units, heating-cooling when connected to air conditioning systems of absorption system, cooling when connected to absorption cooling equipment, heat supply to drying equipment and, in addition, any industrial processing activity requiring heat energy, fulfilling the head demand of thermal energy providers and customers.
